(19) United States
(12) Patent Application Publication
(10) Pub. No.: US 2003/0137625 A1
(43) Pub. Date: Jul. 24, 2003

(54) Liquid crystal display and electronic instrument

(75) Inventors: Tsuyoshi Okazaki, Suwa-shi (JP); Kinya Ozawa, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/323,914

(22) Filed: Dec. 20, 2002

(30) Foreign Application Priority Data
Dec. 25, 2001 (JP) 2001-392902

(51) Int. Cl. G02F 1/1335

(52) U.S. Cl. 349/113; 349/155

(57) ABSTRACT

In a liquid crystal display having a cholesteric liquid crystal layer formed on a substrate, fluctuations in cell thickness of a liquid crystal layer due to fluctuations in layer thickness of the cholesteric liquid crystal layer are prevented. A liquid crystal display 10 includes upper and lower substrates 14 and 13, which oppose each other and are bonded to each other with a sealing material 15; a liquid crystal layer 16 clamped between the upper and lower substrates 14 and 13; a liquid crystal cell 11 having a first conductive section 32 disposed on the internal surface of the lower substrate 13 and a second conductive section 25 disposed on the internal surface of the upper substrate 14; and a transflective layer 18 having a cholesteric liquid crystal layer, which is disposed between the lower substrate 13 and the first conductive section 32; wherein the cholesteric liquid crystal layer provided on the lower substrate 13 is formed to the underside of the sealing material 15 for bonding the upper and lower substrates 14 and 13 together.

### BACKGROUND OF THE INVENTION

1. Field of Invention

The present invention relates to a liquid crystal display and an electronic instrument, and more specifically, it relates to an arrangement of the liquid crystal display capable of preventing defective display due to thickness fluctuations of a cholesteric liquid crystal layer in bonding operation of substrates having the cholesteric liquid crystal with a sealing material.

2. Description of Related Art

Reflective liquid crystal displays have been widely used in various portable electronic instruments because of small power consumption due to not having backlight. However, since the reflective liquid crystal display performs display using external light such as natural light and illumination light, there has been a problem that display is difficult in visibility at a dark place. Then, a display is proposed in that the external light being used at a bright place while an internal light source is used for dark place visibility. That is, this liquid crystal display adopts a display system combining a reflective with a transmission type, and by switching between a reflection mode and a transmission mode corresponding to ambient brightness, clear display can be performed even in ambient darkness while power consumption being reduced. In this specification, such a liquid crystal display is referred to as “a transflective liquid crystal display” below.

There is a proposed transflective liquid crystal display having a reflection film made of a metallic film such as aluminum with slits (openings) for light transmission formed on an internal surface of a lower substrate (in this specification, a substrate surface toward liquid crystal may be referred to as the internal surface, and the surface opposite thereto may be referred to as an external surface below.), so as to function as a transflective film. The liquid crystal display has an advantage preventing a parallax effect due to the thickness of the lower substrate, and preventing color mixture especially in a structure using a color filter.

FIG. 7 shows an example of a transflective liquid crystal display using such a transflective film.

In the liquid crystal display 100, between a pair of transparent substrates 101 and 102, a liquid crystal layer 103 is clamped; on the lower substrate 101, a reflection film 104 and an insulating film 106 are deposited, and further a lower electrode 108 made of a transparent conductive film such as indium tin oxide (abbreviated to as ITO below) is formed thereon, and an orientational film 107 is formed so as to cover the lower electrode 108. On the other hand, on the upper substrate 102, dye layers 120 of R(red), G(green), and B(blue) are formed, and a planarization film 111 is deposited thereon to form a color filter layer 109. On the planarization film 111, an upper electrode 112 made of the transparent conductive film such as ITO is formed, and an orientational film 113 is formed so as to cover the upper electrode 112.

The reflection film 104 made of a metallic film with a high reflectance factor, such as aluminum, has slits 110 formed therein for light transmission for each pixel. By these slits 110, the reflection film 104 serves as a transflective film (this film is therefore referred to as a transflective film, below.). The external surface of the upper substrate 102 is provided with a front scattering plate 118, a retardation plate 119, and an upper polarizing plate 114, which are arranged in that order from the upper substrate 102, while the external surface of the lower substrate 101 is provided with a quarter wave plate 115 and a lower polarizing plate 116 arranged in that order. A backlight unit (illumination unit) 117 is arranged under the lower substrate 101 and further below the lower polarizing plate 116.

When the liquid crystal display 100 shown in FIG. 7 is used at a bright place in the reflection mode, external rays such as sunlight or illumination rays being incident from above the upper substrate 102 pass through the liquid crystal layer 103 and are reflected by the surface of the reflection film 104 on the lower substrate 101; then the rays pass through the liquid crystal layer 103 again so as to be emitted toward the upper substrate 102. When being used at a dark place in the transmission mode, light rays emitted from the backlight unit 117 arranged under the lower substrate 101 pass through the slits 110 of the reflection film 104; then the rays pass through the liquid crystal layer 103 so as to be emitted toward the upper substrate 102. Thereby, the both rays contribute to the display in each mode.

For a reflection layer of such a reflective liquid crystal display, a metallic film with a high reflectance factor, such as aluminum and silver, has been conventionally used. Whereas recently, a dielectric mirror, which is made by alternately depositing dielectric thin films with different refraction indexes, a cholesteric reflection plate using cholesteric liquid crystal, and a hologram reflection plate using a hologram element are proposed. These new reflection plates have not only a function to simply reflect light rays but also have specific functions utilizing features of construction materials.

Above all, the cholesteric liquid crystal becomes a state of a liquid crystal phase at a temperature (liquid crystal transition temperature) or more, and in the liquid crystal phase, a liquid crystal molecule has a periodical spiral structure with a constant pitch. Because of such a structural property, the cholesteric liquid crystal selectively reflects a light ray with a wavelength matching with the pitch of the spiral while allowing other light rays to pass therethrough. Since the pitch of the spiral can be controlled by the ultraviolet ray intensity and temperature during curing liquid crystal, a reflection light color can be therefore changed locally, enabling the cholesteric liquid crystal to be also used as a reflective color filter.

Also, in depositing a plurality of the cholesteric liquid crystal layers selectively reflecting different color light rays, the entire deposited structure can also serve as a reflection plate for reflecting white light.

### SUMMARY OF THE INVENTION

In a reflective liquid crystal display using the cholesteric liquid crystal layer described above, as the cholesteric liquid crystal layer is used as a reflection plate or a color filter, it has been usual to form the cholesteric liquid crystal layer in a display region, i.e., a predetermined region inside the sealing material. The cholesteric liquid crystal layer is required to have a certain measure of thickness in being used as the reflection plate or the color filter. During bonding the substrate having the cholesteric liquid crystal layer formed thereon at a predetermined clearance (cell thickness), fluctuations in the film thickness of the cholesteric liquid crystal layer directly affect the cell thickness of the liquid crystal layer, resulting in changes in retardation (Δn·d) of the liquid crystal layer (wherein Δn is a phase contrast of the liquid crystal layer and d is a cell thickness of the liquid crystal), and producing problems of reduction in display quality and reduction in yield. These problems are not limited to a passive-matrix type or active-matrix type reflective liquid crystal display using the cholesteric liquid crystal layer, but in a passive-matrix type or active-matrix type transflective liquid crystal display using the cholesteric liquid crystal layer, similar problems may also arise.

In the conventional transflective liquid crystal display as shown in FIG. 7, although the display is visible regardless of the existence of the external light, there has been a problem that display brightness in the transmission mode is far reduced in comparison with that in the reflection mode. This problem results from facts that only a substantially half of the light emitted from the backlight can be used as the display in the transmission mode; the display in the transmission mode uses only the light, which passes through the slits of the transflective film; and the lower substrate is provided with the quarter wave plate and the lower polarizing plate arranged on the external surface thereof.

In the conventional transflective liquid crystal display, the display has different modes for reflection and transmission. In particular, in the transmission mode, a substantially half of the light emitted from the backlight is absorbed in the upper polarizing plate, so that the remaining substantially half thereof is only used for the display. That is, whereas in the reflection mode, almost all linearly polarized light incident from the upper substrate is used for a bright display, in the transmission mode, the light proceeding from the bottom surface of the liquid crystal layer toward the upper substrate has to be substantially circular polarized light for performing the same display as in the reflection mode. However, a half of the circular polarized light is absorbed by the upper polarizing plate during being emitted outside from the upper substrate, and as a result, only a substantially half of the light incident in the liquid crystal layer is contributed to the display. In such a manner, first of all, the display brightness in the transmission mode is principally reduced.

Also, since the display is performed by using the light transmitting the slits in the transmission mode, the ratio of slit area to the entire transflective film area (i.e., the opening ratio) influences the display brightness. The increase in the opening ratio enables the display in the transmission mode to be brightened; however, the nonopening area of the transflective film is thereby reduced, so that the display in the reflection mode becomes dark. Therefore, the opening ratio of the slits cannot be increased more than some extent for maintaining the brightness in the reflection mode, and there is a limit in improving the brightness in the transmission mode.

The transflective liquid crystal display requires the quarter wave plate arranged on the external surface of the lower substrate according to a display principle; the reason that the brightness in the transmission mode runs short by the presence of the quarter wave plate will be described below. In the description, a dark display is performed in a nonselective voltage impressed state and a bright display is performed in a selective voltage impressed state.

First, in the case of the dark display in the reflection mode performed by the liquid crystal display shown in FIG. 7, the light incident from outside of the upper substrate 102 becomes linearly polarized light having a polarization axis parallel to the plane of the figure by transmitting the upper polarizing plate 114 on the upper substrate 102 when a transmission axis of the upper polarizing plate 114 is parallel to the plane of the figure; the light substantially becomes circularly polarized light during transmitting the liquid crystal layer 103 because of a birefringent effect of the liquid crystal layer 103. Then, the light is reflected by the surface of the transflective film 104 on the lower substrate 101 to become the counterrotating circularly polarized light; then, it again passes through the liquid crystal layer 103 to become linearly polarized light having a polarization axis perpendicular to the plane of the figure and to reach the upper substrate 102. Since the upper polarizing plate 114 of the upper substrate 102 has the polarization axis parallel to the plane of the figure, the light reflected by the transflective film 104 is absorbed by the upper polarizing plate 114 so as not to return outside the liquid crystal display (toward an observer), so that the dark display is performed by the liquid crystal display 100.

In contrast, in the case of the bright display in the reflection mode, since an orientational direction of the liquid crystal layer 103 is changed by voltage application, the outside light incident from outside of the upper substrate 102 becomes linearly polarized light by transmitting the liquid crystal layer 103 so as to be reflected as it is by the transflective film 104; the light passes through the upper polarizing plate 114 on the upper substrate 102 in the state of the linearly polarized light having a polarization axis parallel to the plane of the figure so as to return outside (toward an observer), so that the bright display is performed by the liquid crystal display 100.

On the other hand, in the case of the display in the transmission mode performed by the liquid crystal display 100, the light emitted from the backlight unit 117 enters a liquid crystal cell from outside of the lower substrate 101; among these light rays, the rays transmitting the slits 110 contribute to the display.

In order to perform the dark display in the liquid crystal display 100, the light toward the upper substrate 102 from the slits 110, in the same way as in the reflection mode described above, has to be substantially circularly polarized light. Therefore, it is necessary that the light emitted from the backlight unit 117 to pass through the slits 110 becomes substantially circularly polarized light, so that the quarter wave plate 115 is required for substantially converting the linearly polarized light after transmitting the lower polarizing plate 116 into the circularly polarized light.

With respect to the light rays not passing through the slits 110 among the light rays emitted from the backlight unit 117, if the lower polarizing plate 116 has a polarization axis perpendicular to the plane of the figure, the light rays become linearly polarized light perpendicular to the plane of the figure during transmitting the lower polarizing plate 116; then, the light rays become substantially circularly polarized light by transmitting the quarter wave plate 115 so as to reach the transflective film 104. Furthermore, the light rays become the counterrotating circularly polarized light by being reflected on the bottom surface of the transflective film 104 and become the linearly polarized light having a polarization axis parallel to the plane of the figure by transmitting the quarter wave plate 115 again. Then, this linearly polarized light is absorbed by the lower polarizing plate 116 having the transmission axis perpendicular to the plane of the figure. That is, the almost entire light not passing through the slits 110 among the light emitted from the backlight unit 117 is absorbed by the lower polarizing plate 116 on the lower substrate 101 after reflecting on the bottom surface of the transflective film 104.

In such a manner, in the transflective liquid crystal display 100, in the transmission mode, the almost entire light, which does not pass through the slits 110 and is reflected by the transflective film 104, is absorbed by the lower polarizing plate 116 on the lower substrate 101, so that only part of the light emitted from the backlight unit 117 can be used for the display. If the light were not absorbed by the lower polarizing plate 116 to return to the backlight unit 117 by passing through the lower polarizing plate 116, the brightness of the backlight unit 117 could be effectively improved by this returned light in addition to the originally emitting light therefrom, so that the brightness in the transmission mode could be improved. In other words, if the light, which does not pass through the slits 110 and is reflected by the transflective film 104, can be reused for the display, the brightness in the transmission mode can be improved. However, in the conventional arrangement, this cannot be achieved.

The cholesteric liquid crystal layer of the reflection layer or the transflective layer provided in the liquid crystal display is made to have a liquid crystal molecule having a periodical spiral structure with a constant pitch by controlling the intensity or temperature of ultraviolet light during curing the cholesteric liquid crystal by irradiating it with the ultraviolet light after coating a rubbing-treated alignment film with the cholesteric liquid crystal by various coating methods such as a spin coating method so as to control the spiral pitch of the liquid crystal molecule. The cholesteric liquid crystal layer may reflect at least part of elliptically polarized light having a predetermined rotational direction, or may reflect at least part of elliptically polarized light having a predetermined rotational direction while transmitting part thereof. However, during forming such a cholesteric liquid crystal layer, fluctuations in the film thickness are produced, resulting in a fluctuation in the space between the upper and lower substrates (the film thickness of the liquid crystal layer, which may be referred to as a cell thickness below).

The present invention has been made in order to solve the above-mentioned problem, and it is an object thereof to provide a liquid crystal display capable of preventing fluctuations in a cell thickness due to fluctuations in the film thickness of a cholesteric liquid crystal layer when a substrate having the cholesteric liquid crystal layer is bonded with a sealing material at a predetermined space (the cell thickness) so as to extend the cholesteric liquid crystal layer toward under the sealing material.

In a liquid crystal display especially having the cholesteric liquid crystal layer functioning as a transflective layer, it is another object of the present invention to provide a liquid crystal display with excellent visibility, in which the brightness especially in a transmission mode is improved.

Also, it is another object of the present invention to provide an electronic instrument having a liquid crystal display with high reliability, in which reduction in yield due to fluctuations in the cell thickness when the substrate having the cholesteric liquid crystal layer is bonded with the sealing material cannot occur.

Also, it is another object of the present invention to provide an electronic instrument having the above-mentioned liquid crystal display with excellent visibility.

In order to achieve the above-mentioned object, a liquid crystal display according to the present invention comprises upper and lower substrates, which oppose each other and are bonded to each other with a sealing material; a liquid crystal layer clamped between the upper and lower substrates; a liquid crystal cell having a first conductive section disposed toward the internal surface of the lower substrate and a second conductive section disposed toward the internal surface of the upper substrate; a reflection layer, which is disposed between the lower substrate and the first conductive section and has a cholesteric liquid crystal layer for reflecting at least part of elliptically polarized light having a predetermined rotational direction; upper-substrate side elliptically-polarized-light projecting means for projecting elliptically polarized light from the upper substrate toward the liquid crystal layer; and lower-substrate side elliptically-polarized-light projecting means for projecting elliptically polarized light from the lower substrate toward the liquid crystal layer, wherein the liquid crystal layer inverts the polarity of incident elliptically polarized light in any one of a selective electric-field impressed state and a nonselective electric-field impressed state while the liquid crystal layer does not invert the polarity in the other state, and wherein in order to clamp the liquid crystal layer at a predetermined clearance, at least part of the cholesteric liquid crystal layer exists under the sealing material disposed for clamping the liquid crystal layer between the upper and lower substrates at a predetermined clearance.

Wherein “the first conductive section” and “the second conductive section” represent wiring such as data lines and scanning lines in an active-matrix type liquid crystal display or electrodes such as segment electrodes and common electrodes in a passive-matrix type liquid crystal display. Furthermore, in exemplifying the active-matrix type liquid crystal display, one of the first and second conductive sections represents the data lines while the other represents the scanning lines.

In the liquid crystal display according to the present invention and structured as described above, in order to clamp the liquid crystal layer at a predetermined clearance, there is mixed a spacer such as a silica ball and glass fiber, and the sealing material for bonding the upper and lower substrates may have any shape or material as long as it can bond the upper substrate to the lower substrate at a predetermined clearance.

In the liquid crystal display according to the present invention and structured as described above, the reflection layer may be a transflective layer having the cholesteric liquid crystal layer for reflecting part of elliptically polarized light having a predetermined rotational direction and for transmitting the other part thereof, and the reflection layer may be provided with the lower-substrate side elliptically-polarized-light projecting means for projecting elliptically polarized light from the lower substrate. Such a liquid crystal display may be a transflective liquid crystal display.

The cholesteric liquid crystal layer of the reflection layer or the transflective layer provided in the liquid crystal display is made to have a liquid crystal molecule having a periodical spiral structure with a constant pitch by controlling the intensity or temperature of ultraviolet light during curing the cholesteric liquid crystal by irradiating it with the ultraviolet light after coating a rubbing-treated alignment film with the cholesteric liquid crystal by various coating methods such as a spin coating method so as to control the spiral pitch of the liquid crystal molecule. The cholesteric liquid crystal layer may reflect at least part of elliptically polarized light having a predetermined rotational direction while transmitting part thereof.

However, the inventors found that during bonding the lower substrate having the reflection layer and transflective layer comprising such the cholesteric liquid crystal layer formed thereon to the upper substrate with a sealing material at a predetermined clearance, fluctuations in the film thickness of the cholesteric liquid crystal layer directly affect the cell thickness of the liquid crystal layer, resulting in changes in retardation (Δn·d) of the liquid crystal layer, and producing problems of reduction in display quality such as brightness nonuniformity and color nonuniformity. The inventor has considered that this problem comes from a fact that the cholesteric liquid crystal layer on the lower substrate is only formed in the inside region of the sealing layer from the inner edge thereof.

In taking an extreme example, when the cholesteric liquid crystal layer is formed as thick as about 10 μm and the liquid crystal layer thickness is set at 3 μm in design, a step of 10 μm exists in the inside region of the sealing material and the clearance between the upper and lower substrates is 13 μm, so that the diameter of the spacer of the sealing material is required to have 13 μm. In this situation, even when the clearance between the upper and lower substrates is precisely maintained as 13 μm, if the cholesteric liquid crystal layer thickness, which dominates a large part of 13 μm, fluctuates by 10%, for example, the liquid crystal layer thickness fluctuates to be 3 μm±1 μm, disabling the display to be performed.

Then, according to the present invention, the cholesteric liquid crystal layer provided on the lower substrate is formed to the underside of the sealing material for bonding the upper substrate to the lower substrate, so that even when the cholesteric liquid crystal layer thickness fluctuates, the liquid crystal layer thickness (cell thickness) can be constant as long as the clearance between the upper and lower substrates is precisely maintained by the spacer within the sealing material located above. As a result, fluctuations in the layer thickness of the cholesteric liquid crystal layer cannot directly affect the cell thickness, enabling improved yield due to reduction in defective display and improved reliability.

The color filter layer comprises a plurality of dye layers having different color pigments formed on the reflection layer or transflective layer by photolithography or the like and a planarizing film (overcoat) applied thereon for protecting the dye layers and for planarizing steps due to the dye layers as well. Since the planarizing film cannot unify the film thickness of the dye layers, if the sealing material is not located on the underside of the color filter layer, fluctuations in the film thickness of the color filter layer affect the cell thickness, resulting in changes in retardation (Δn·d) of the liquid crystal layer, and producing problems of reduction in display quality of the liquid crystal display such as brightness nonuniformity and color nonuniformity.

Then, according to the present invention, the color filter layer provided on the lower substrate is formed to the underside of the sealing material for bonding the upper substrate to the lower substrate, so that fluctuations in the film thickness of the color filter layer cannot directly affect the cell thickness, enabling improved yield due to reduction in defective display and improved reliability.

The cholesteric liquid crystal layer according to the present invention selectively reflects circularly polarized light having the same wavelength as the spiral pitch of a liquid crystal molecule and the same rotational direction as the spiral winding direction, i.e., having so-called selective reflectiveness. Conversely, the light with a wavelength different from the spiral pitch of the liquid crystal molecule or the circularly polarized light with the rotational direction opposite to the spiral winding direction even having the same wavelength as the spiral pitch of the liquid crystal molecule can be transmitted through the cholesteric liquid crystal layer. Furthermore, the cholesteric liquid crystal layer according to the present invention has a function to reflect at least part of circularly polarized light having the same wavelength as the spiral pitch of the liquid crystal molecule and the same rotational direction as the spiral winding direction. Therefore, the cholesteric liquid crystal layer, which reflects the entire circularly polarized light having the same wavelength as the spiral pitch of the liquid crystal molecule and the same rotational direction as the spiral winding direction, serves as the reflection layer while the cholesteric liquid crystal layer, which reflects part of circularly polarized light having the same wavelength as the spiral pitch of the liquid crystal molecule and the same rotational direction as the spiral winding direction, serves as a transflective layer.

Also, the cholesteric liquid crystal layer according to the present invention may have a function to reflect part of circularly polarized light having the same wavelength as the spiral pitch of the liquid crystal molecule and the same rotational direction as the spiral winding direction while transmitting the other part thereof. Such a cholesteric liquid crystal layer serves as a transflective layer.

The inventors have found that in the reflective liquid crystal display using the reflection layer comprising the cholesteric liquid crystal, which is recently proposed, if the light to be projected to the liquid crystal cell is in the elliptically polarized state, and the liquid crystal mode is established so as to invert the polarity of the elliptically polarized state in any one of a selective electric-field impressed state to the liquid crystal layer and a nonselective electric-field impressed state, the display mode can be the same between in reflection and in transmission, so that in the transmission mode, the display does not become dark in display principle. It is also found that during the transmission display, the light reflected toward the lower substrate by the selective reflection of the cholesteric liquid crystal could be reused even if the arrangement of the external side of the lower substrate is as usual. Focusing attention on these points, the arrangement according to the present invention has been proposed.

The display principle of the liquid crystal display according to the present invention used as a transflective type and the reason that the light reflected by the transflective layer can be reused will be described below with reference to FIG. 3. It is noted that the display principle of the liquid crystal display according to the present invention used as a reflective type is substantially the same as that of the reflection bright display and the reflection dark display when being used as the transflective type.

FIG. 3 is a drawing for illustrating the display principle of the liquid crystal display according to the present invention.

Between a pair of transparent upper and lower substrates 14 and 13, a liquid crystal layer 3 is clamped so as to constitute a liquid crystal cell 11. To the internal surface of the lower substrate 13, a transflective layer 18 comprising a cholesteric liquid crystal layer is arranged. The cholesteric liquid crystal layer reflects part of circularly polarized light having a predetermined rotational direction while transmitting the other part thereof. According to the present invention, 80% of circularly polarized light rotating in the right direction (referred to as right circularly polarized light below) is reflected while 20% thereof is transmitted, for example.

The liquid crystal display according to the present invention comprises upper-substrate side elliptically-polarized-light projecting means for projecting elliptically polarized light from the upper substrate 14 toward a liquid crystal layer 16, and in FIG. 4, an upper polarizing plate 36 for transmitting linearly polarized light in one direction and an upper quarter wave plate 35 inverting the linearly polarized light transmitted through the upper polarizing plate 36 into circularly polarized light constitute the upper-substrate side elliptically-polarized-light projecting means. Furthermore, referring to FIG. 3, there is also provided lower-substrate side elliptically-polarized-light projecting means for projecting elliptically polarized light from the lower substrate 13 toward the liquid crystal layer 16, and a lower polarizing plate 28 and a lower quarter wave plate 27 constitute the lower-substrate side elliptically-polarized-light projecting means in the same way as in the upper substrate side. Wherein the transmission axis of each of the polarizing plates on both sides of upper and lower substrates 14 and 13 has the direction parallel to the plane of FIG. 3, and when the linearly polarized light in this direction enters the quarter wave plate, right circularly polarized light is emitted therefrom.

The liquid crystal layer 16 inverts a rotational direction of incident circularly polarized light corresponding to the presence or absence of electric-field impression. During the impression of nonselective electric-field (liquid crystal is in the OFF state), a liquid crystal molecule has a phase difference of λ/2 (λ: wavelength of incident light) in a lying state, so that incident right circularly polarized light is inverted into left circularly polarized light after passing through the liquid crystal layer while the left circularly polarized light is inverted into the right circularly polarized light. On the other hand, during the impression of selective electric-filed (liquid crystal is in the ON state), the liquid crystal molecule has not the phase difference in a rising state, so that the rotational direction of the circularly polarized light is not changed.

In the liquid crystal display shown in FIG. 3, in performing the bright display in the reflection mode (the left end of FIG. 3), the light incident from outside the upper substrate 14 becomes linearly polarized light having a polarization axis parallel to the plane of the figure by transmitting the upper polarizing plate 36 on the upper substrate 14; then, it becomes right circularly polarized light by transmitting the upper quarter wave plate 35. At this time, if the liquid crystal is in the ON state, since the rotational direction of the circularly polarized light is not changed as described above, the right circularly polarized light incident in the liquid crystal layer 16 remains being the right circularly polarized light even when the light reaches the transflective layer 18 by transmitting the liquid crystal layer 16.

The principal difference between a conventional transflective layer using a metallic film and the transflective layer 18 using the cholesteric liquid crystal according to the present invention is that in the transflective layer using a metallic film, the rotational direction of circularly polarized light is reversed by reflection, i.e., right circularly polarized light is inverted into left circularly polarized light by reflection, while in the transflective layer 18 using the cholesteric liquid crystal, the rotational direction of circularly polarized light is not changed by reflection, i.e., right circularly polarized light remains the right circularly polarized light even when being reflected. Accordingly, 80% of the right circularly polarized light transmits the liquid crystal layer 16 again toward the upper substrate after being reflected by the transflective layer 18 on the lower substrate. At this time, since the liquid crystal is also in the ON state, the light remains being right circularly polarized light; however, by transmitting the upper quarter wave plate 35, the light then is inverted into linearly polarized light having a polarization axis parallel to the plane of the figure. This linearly polarized light can transmit the upper polarizing plate 36 so that it returns outside (toward an observer) and the liquid crystal display performs the bright display.

In contrast, in performing the dark display in the reflection mode (second from the right in FIG. 3), if the liquid crystal is in the OFF state, the right circularly polarized light incident from the upper substrate 14 becomes left circularly polarized light by transmitting the liquid crystal layer 16 because the liquid crystal layer 16 has a phase difference of λ/2. In FIG. 3, since the cholesteric liquid crystal constituting the transflective layer consistently reflects part of right circularly polarized light, left circularly polarized light transmits the transflective layer. Then, the left circularly polarized light is inverted into linearly polarized light having a polarization axis perpendicular to the plane of the figure by transmitting the lower quarter wave plate. This linearly polarized light is absorbed by the lower polarizing plate, so that it does not return outside (toward an observer) and the liquid crystal display performs the dark display.

On the other hand, in performing the display in the transmission mode, the light emitted from the backlight unit, for example, enters the liquid crystal cell 11 from outside the lower substrate 13 so as to contribute to the display. In performing the dark display in the transmission mode (right end in FIG. 3), an effect similar to that in the reflection mode is produced from the lower substrate toward the upper substrate. That is, the lower substrate is also provided with the lower polarizing plate 28 and the lower quarter wave plate 27 similarly to the upper substrate, 20% of the circularly polarized light incident in the liquid crystal layer 16 from the lower substrate transmits the transflective layer 18. In this case, if the liquid crystal is in the OFF state, it becomes left circularly polarized light upon reaching the upper substrate 14 so as to be inverted into linearly polarized light having a polarization axis perpendicular to the plane of the figure by transmitting the upper quarter wave plate 35. Since this linearly polarized light is absorbed into the upper polarizing plate 36, it is not emitted outside (toward an observer) and the liquid crystal display performs the dark display.

In performing the bright display in the transmission mode (second from the left in FIG. 3), the light incident from the lower substrate 13 becomes linearly polarized light having a polarization axis parallel to the plane of the figure by transmitting the lower polarizing plate 28, then it becomes right circularly polarized light to be emitted by transmitting the lower quarter wave plate 27. Twenty percent of this emitted light can transmit the transflective layer 18 made of the cholesteric liquid crystal so as to be emitted as right circularly polarized light. If the liquid crystal is in the ON state, the 20% right circularly polarized light reaches the upper substrate 14 maintaining the polarized state. Then, the right circularly polarized light is inverted into linearly polarized light having a polarization axis parallel to the plane of the figure by transmitting the upper quarter wave plate 35. Since this linearly polarized light can transmit the upper polarizing plate 36, it returns outside (toward an observer) and the liquid crystal display performs the bright display.

On the other hand, in performing the bright display in the transmission mode, 80% of right circularly polarized light reflects on the transflective layer 18 made of the cholesteric liquid crystal toward the underside. At this time, as described above, since the cholesteric liquid crystal has a property that it does not change the rotational direction of the reflected circularly polarized light, the reflected light is the right circularly polarized light. Therefore, then by transmitting the lower quarter wave plate 27, the right circularly polarized light becomes linearly polarized light having a polarization axis parallel to the plane of the figure, which can transmit the lower polarizing plate 28 having a transmission axis parallel to the plane of the figure. In such a manner, when the linearly polarized light having the same polarization axis as that the transmission axis of the lower polarizing plate 28 is emitted from the lower substrate 13, this light is led toward the liquid crystal cell again and reused for the display by reflecting, for example, on the reflection plate 40 provided in the backlight unit 12.

Although the description is omitted above, also in performing the dark display in the transmission mode, the light incident from the lower substrate 13 becomes linearly polarized light having a polarization axis parallel to the plane of the figure by transmitting the lower polarizing plate 28, then it becomes right circularly polarized light to be emitted by transmitting the lower quarter wave plate 27. Eighty percent of this right circularly polarized light reflects on the transflective layer 18 made of the cholesteric liquid crystal and is led to the liquid crystal cell 11 again after being once emitted from the lower substrate 13 toward the outside of the liquid crystal cell 11; this light is anyhow absorbed into the upper polarizing plate 36, so that this does not particularly work against the dark display. Also, in performing the bright display in the reflection mode, since 20% of right circularly polarized light incident from the above transmits the transflective layer 18, it is led to the liquid crystal cell 11 again after being once emitted from the lower substrate 13 toward the outside of the liquid crystal cell 11. This light contributes to the display, enabling the display in the reflection mode to be brightly maintained.

As described above, in the liquid crystal display according to the present invention, the same display mode can be used in the reflection as well as in the transmission. Focusing attention especially on the bright display in the transmission mode, part of the light incident from the lower substrate is not absorbed into the upper polarizing plate as is in the conventional transflective liquid crystal display, and the almost entire light transmitted through the transflective layer 18 made of the cholesteric liquid crystal contributes to the display. On the other hand, the light reflected on the transflective layer 18 made of the cholesteric liquid crystal can be reused for the display. Obviously, the rate in the cholesteric liquid crystal of reflection: 80% and transmission: 20% used in the above description is only an example; the rate may be changed in any wise. However, in any rate, by the additive effects that the circularly polarized light transmitted through the transflective layer 18 made of the cholesteric liquid crystal can be utilized utmost and the circularly polarized light reflected on the transflective layer 18 can be reused for the display, the liquid crystal display can improve the brightness of the transmission display more than it was while maintaining the brightness of the reflection display, so that a transflective-type liquid crystal display excellent in visibility can be achieved.

In the description above, both light rays led from the upper substrate and lower substrate are “right circularly polarized light” as ideal configurations; however, in order to achieve the operation of the liquid crystal display according to the present invention, it is not necessarily perfect circularly polarized light, and it may be “elliptically polarized light” in a broad sense.

In the liquid crystal display according to the present invention, it is preferable that an illuminating unit be provided for projecting light from the lower substrate to the liquid crystal cell.

In the liquid crystal display according to the present invention, in order to equalize the transmission display mode with the reflection display mode, it is required to project elliptically polarized light from the lower substrate side by some kind of means. For this purpose, any means may be used; for example, by providing an illuminating unit for projecting light from the lower substrate side to the liquid crystal cell, which is called as a backlight unit, the arrangement for projecting elliptically polarized light from the lower substrate side may be easily achieved.

As the specific arrangements of the upper-substrate side elliptically-polarized-light projecting means and the lower-substrate side elliptically-polarized-light projecting means, a polarizing plate for transmitting linearly polarized light in one direction and a phase difference plate for inverting the linearly polarized light transmitted through the polarizing plate into elliptically polarized light may constitute these means.

By arranging these two optical members on the upper and lower substrates, respectively, outside light such as sun light and illuminating light and the illuminating light emitted from the backlight unit can be easily inverted into elliptically polarized light, achieving an excellent liquid crystal display according to the present invention.

As the phase difference plate, any plate having an arbitrary phase difference may be selected; it is preferable to use a quarter wave plate.

In using the quarter wave plate, the linearly polarized light emitted from the polarizing plate can be inverted especially into circularly polarized light among elliptically polarized light in a broad sense, so that the light-utilizing efficiency can be improved to the utmost, achieving a liquid crystal display with more brighter display. However, in order to have a color-correction function in the phase difference plate arranged on the upper substrate, any plate having an arbitrary phase difference may be selected not limited to the quarter wave plate.

The cholesteric liquid crystal layer serves as a reflective-type color filter for selectively reflecting chromatic light with a different wavelength corresponding to a spiral pitch of a liquid crystal molecule for each predetermined region, which may use a waveband for each of the predetermined region, in which the reflection waveband of the cholesteric liquid crystal layer and the transmission waveband of each dye layer of the color filter layer are at least partly overlapped. In other words, for each predetermined region, a color may be used, in which a color of light reflected from the cholesteric liquid crystal layer agrees with a reflected color of each dye layer of the color filter layer.

The cholesteric liquid crystal layer in the liquid crystal display according to the present invention can serve as a reflection layer, which is so called as a white reflection layer, for reflecting circularly polarized light containing various wavebands by depositing a plurality of layers with different spiral pitches of liquid crystal molecules. Also, by changing the spiral pitch of a liquid crystal molecule for each predetermined region so as to selectively reflect the light with a wavelength corresponding to the spiral pitch in the region, the cholesteric liquid crystal layer also serves as a reflective-type color filter for reflecting light rays, for example, of red (R), green (G), and blue (B), respectively for each region. In serving as the reflective-type color filter, the color display with a color different for each dot within the display region can be performed by the display principle. In this case, the cholesteric liquid crystal layer principally serves as a color filter for reflection display while the color filter layer containing pigments principally serves as a color filter for transmission display.

In the liquid crystal display according to the present invention with any one of arrangements described above, between the reflection layer or transflective layer and the first conductive section, the color filter layer having a plurality of dye layers containing different color pigments may be disposed.

Such an arrangement of the liquid crystal display enables color display to be performed.

The transflective-type liquid crystal display according to the present invention can achieve a transflective liquid crystal display with excellent visibility in which the color display brightness especially in the transmission mode is improved.

An electronic instrument according to the present invention comprises the liquid crystal display according to the present invention with any one of arrangements described above.

According to this arrangement, a highly reliable electronic instrument can be provided, in which fluctuations in cell thickness due to fluctuations in film thickness of the cholesteric liquid crystal layer can be reduced and reduction in yield due to defective display is eliminated. Moreover, since fluctuations in cell thickness due to fluctuations in film thickness of the color filter can be reduced, reduction in yield due to defective display is eliminated, and an electronic instrument with improved reliability can be achieved.

Also when a display section of the instrument is provided with the transflective-type liquid crystal display according to the present invention, there is provided an electronic instrument having a liquid crystal display section with excellent visibility, in which the display in the transmission mode is also bright.

### BRIEF DESCRIPTION OF THE DRAWINGS

FIG. 1 is a drawing showing a sectional arrangement of a liquid crystal display according to a first embodiment of the present invention.

FIG. 2 is a drawing showing a partially enlarged sectional arrangement of the liquid crystal display according to the first embodiment of the present invention.

FIG. 3 is a schematic view for illustrating the display principle of the liquid crystal display according to the first embodiment.

FIG. 4 is a perspective view showing an example of an electronic instrument according to the present invention.

FIG. 5 is a perspective view showing another example of an electronic instrument according to the present invention.

FIG. 6 is a perspective view showing still another example of an electronic instrument according to the present invention.

FIG. 7 is a sectional view showing an example of a conventional liquid crystal display.

### DETAILED DESCRIPTION OF PREFERRED EMBODIMENTS

[First Embodiment: Liquid Crystal Display]

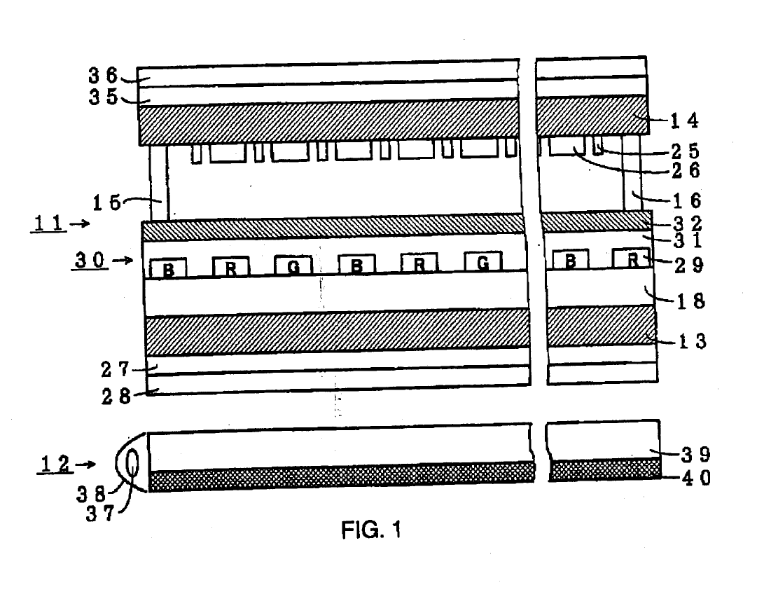

A first embodiment according to the present invention will be described below with reference to FIG. 1.

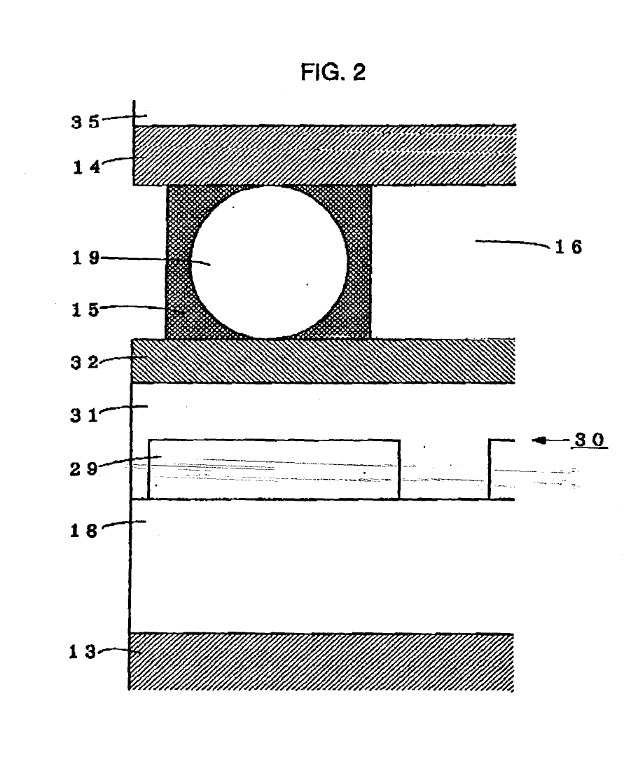

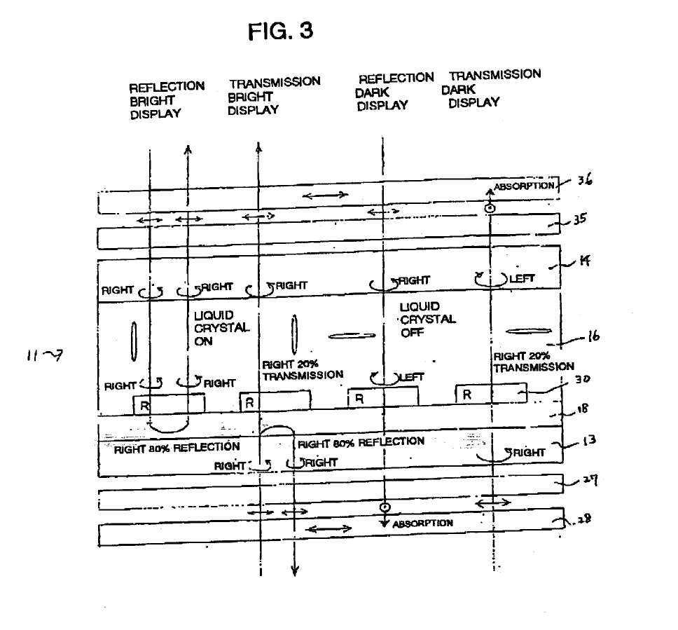

FIG. 1 shows a partial sectional structure of a liquid crystal display according to the embodiment; FIG. 2 shows a partial sectional structure in the vicinity of a sealing material of the liquid crystal display according to the embodiment; and FIG. 3 is a drawing for illustrating a display principle of the liquid crystal display according to the first embodiment. The embodiment is an example of an active-matrix-type transflective liquid crystal display using a thin film diode (referred to as the TFD below) as a switching element. In addition, in the drawings below, the film thickness and dimensional proportion of each element are appropriately changed for drawing visibility.

A liquid crystal display 10 according to the embodiment, as shown in FIG. 1, comprises a liquid crystal cell 11 and a backlight unit 12 (an illumination unit). The liquid crystal cell 11 is provided with lower and upper substrates 13 and 14, which are arranged to oppose each other, and a liquid crystal layer 16 made of super twisted nematic (STN) liquid crystal with a phase difference of λ/2 set thereto and clamped between the lower and upper substrates 13 and 14. Under the liquid crystal cell 11 (the external surface side of the lower substrate 13), the backlight unit 12 is arranged. The backlight unit 12 comprises a light source 37 comprising an LED (a light-emitting diode), a light-guide plate 39, and a reflection plate 40.

On the internal surface of the lower substrate 13 made of a light-transmissive material such as glass and plastics, a transflective film 18 is formed by alternately depositing an alignment film and a cholesteric liquid crystal layer.

A plurality of the cholesteric liquid crystal layers deposited in the transflective film 18 allow part of circularly polarized light having a predetermined rotational direction to be reflected while allowing part thereof to be transmitted. According to the embodiment, the cholesteric liquid crystal layers allow 80% of circularly polarized light rotating in the right direction (referred to as right circularly polarized light below) to be reflected while allowing 20% thereof to be transmitted. Therefore, the entire transflective film 18 has a function to allow 80% of white right circularly polarized light to be reflected while allowing 20% thereof to be transmitted. The thickness of the transflective film 18 is, for example, approximately 5 to 20 μm.

In order to form the transflective film 18: on a glass plate or plastic sheet constituting the lower substrate 13, the alignment film is applied; liquid solution containing the cholesteric liquid crystal is applied on the alignment film by various coating methods such as a spin coating method after rubbing treatment is performed on the alignment film; then, the cholesteric liquid crystal is irradiated with ultraviolet light and cured to form the cholesteric liquid crystal layer. In this case, during the irradiation with the ultraviolet light and the curing, a liquid crystal molecule is allowed to have a periodical spiral structure with a constant pitch by controlling the intensity or temperature of the ultraviolet light so as to control the spiral pitch of the liquid crystal molecule. Then, by alternately repeating the formation of the rubbing-treated alignment film and the formation of the cholesteric liquid crystal layer, the intended transflective liquid crystal film 18 is obtained.

On the transflective liquid crystal film 18, an overcoat layer (not shown) made of a light-transmissive resin material is formed. On the top surface of the overcoat layer, R (red), G (green), and B (blue) of dye layers 29 are repeatedly formed in that row order; a planarizing film 31 for planarizing steps due to the dye layers 29 is further deposited thereon to form a color filter layer 30. On the planarizing film 31, a number of strip-like scanning lines (a first conductive section) 32 made of a transparent conductive film such as ITO extend in the transverse direction viewed in the drawing (the direction parallel to the plane of the figure), and on the scanning lines 32, an alignment film (not shown) made of polyimide or the like is deposited.

The external surface of the lower substrate 13 is provided with a lower quarter wave plate 27, a lower polarizing plate 28, and a reflective polarizing plate 29 arranged in that order. According to the embodiment, lower-substrate-side elliptically-polarized-light projecting means is constituted of the lower polarizing plate 28 and the lower quarter wave plate 27 for allowing elliptically polarized light to enter the liquid crystal layer 16 from the lower substrate 13. According to the embodiment, a transmission axis of the lower polarizing plate 28 is directed in the direction parallel to the plane of FIG. 3, and if the linearly polarized light in this direction enters the lower quarter wave plate 27, right circularly polarized light is emitted therefrom.

On the other hand, the internal surface of the upper substrate 14, made of, for example, a light-transmissive material such as glass and plastics, is provided with a number of strip-like data lines (a second conductive section) 25, which are made of a transparent conductive film such as ITO and extend in the direction perpendicular to the scanning lines (the first conductive section) 32 on the lower substrate 13, and a number of pixel electrodes 26 connected to each of the data lines 25 via TFD elements (not shown). The TFD element comprises a first conductive film made of a tantalum film and a second conductive film, which is made of a metallic film such as chrome, aluminum, titanium, and molybdenum and formed on the surface of the first conductive film. The first conductive film of the TFD element is connected to each of the data lines 25 while the second conductive film is connected to each of the pixel electrodes 26. An alignment film (not shown) made of polyimide or the like is deposited to cover the data lines 25, the pixel electrodes 26, and the TFD elements.

The external surface of the upper substrate 14 is provided with an upper quarter wave plate 35 and an upper polarizing plate 36 arranged in that order from the substrate. According to the embodiment, upper-substrate-side elliptically-polarized-light projecting means is constituted of the upper polarizing plate 36 and the upper quarter wave plate 35 for allowing elliptically polarized light to enter the liquid crystal layer 16 from the upper substrate 14. According to the embodiment, a transmission axis of the upper polarizing plate 36 is directed in the direction parallel to the plane of FIG. 3, and if the linearly polarized light in this direction enters the upper quarter wave plate 35, right circularly polarized light is emitted therefrom.

Within a sealing material 15, as shown in FIG. 2, a spacer 19, such as a silica ball and glass fiber having a particle diameter corresponding to the cell thickness, is mixed so as to clamp the upper and lower substrates 14 and 13 at a constant cell thickness. The sealing material 15, as shown in FIG. 1, is formed on the transflective film 18, which is formed on the lower substrate 13 and made of the cholesteric liquid crystal layer, and the color filter layer 30. In FIG. 2, the transflective film 18 made of the cholesteric liquid crystal layer and the color filter layer 30 are formed to extend until the utmost end of the lower substrate 13, and over the entire region of the sealing material 15 between the lower substrate 13 and the sealing material 15 in the transverse direction, the transflective film 18 and the color filter layer 30 are positioned; however, the transflective film 18 and the color filter layer 30 may be positioned over the part of the region of the sealing material 15 in the transverse direction. Even in this case, it is necessary that the transflective film 18 and the color filter layer 30 are positioned at least under the spacer 19, and it is preferable that the transflective film 18 and the color filter layer 30 be arranged in the range of at least 50% of the width of the sealing material 15 from the inner edge of the sealing material 15.

The liquid crystal layer 16 inverts a rotational direction of incident circularly polarized light corresponding to the presence or absence of selective electric-field impression. During the impression of nonselective electric-field (liquid crystal is in the OFF state), a liquid crystal molecule has a phase difference of λ/2 (λ: wavelength of incident light) in a lying state, so that incident right circularly polarized light is inverted into left circularly polarized light after passing through the liquid crystal layer while the left circularly polarized light is inverted into the right circularly polarized light. On the other hand, during the impression of selective electric-filed (liquid crystal is in the ON state), the liquid crystal molecule has not the phase difference in a rising state, so that the rotational direction of the circularly polarized light is not changed.

The backlight unit 12 comprises the light source 37, a reflection plate 38, and the light-guide plate 39; the bottom surface (opposite to a liquid crystal panel 1) of the light-guide plate 39 is provided with the reflection plate 40 for emitting the light transmitting the light-guide plate 39 toward the liquid crystal cell 11.

The display principle of the liquid crystal display according to the embodiment and the reason that the light reflected by the transflective layer can be reused will be described below with reference to FIG. 3. Wherein the description will be made about a case in that the light incident from outside the upper substrate 14 and outside the lower substrate 13 enters R of the dye layers in the color filter layer 30.

According to the liquid crystal display of the embodiment shown in FIG. 3, in performing the bright display in the reflection mode (the left end of FIG. 3), the light incident from outside the upper substrate 14 becomes linearly polarized light having a polarization axis parallel to the plane of the figure by transmitting the upper polarizing plate 36 on the upper substrate 14; then, it becomes right circularly polarized light by transmitting the upper quarter wave plate 35. At this time, if the liquid crystal is kept in the ON state, since the rotational direction of the circularly polarized light is not changed as described above, the right circularly polarized light incident in the liquid crystal layer remains being the right circularly polarized light even when the light reaches the transflective layer 18 by transmitting the liquid crystal layer 16 and the color filter layer 30.

Accordingly, 80% of the red right circularly polarized light obtained by transmitting R of the dye layers again transmits the liquid crystal layer 16 toward the upper substrate after being reflected by the transflective layer 18 on the lower substrate 13. At this time, since the liquid crystal is also in the ON state, the light remains being right circularly polarized light; however, by transmitting the upper quarter wave plate 35, the light then is inverted into linearly polarized light having a polarization axis parallel to the plane of the figure. This linearly polarized light can transmit the upper polarizing plate 36 so that it returns outside (toward an observer) and the liquid crystal display performs the bright (red) display.

In contrast, in performing the dark display in the reflection mode (second from the right in FIG. 3), if the liquid crystal is in the OFF state, the right circularly polarized light incident from the upper substrate 14 becomes left circularly polarized light by transmitting the liquid crystal layer 16 because the liquid crystal layer 16 has a phase difference of λ/2. In FIG. 3, since the cholesteric liquid crystal constituting the transflective layer 18 consistently reflects part of right circularly polarized light, left circularly polarized light transmits the transflective layer 18. Then, the left circularly polarized light is inverted into linearly polarized light having a polarization axis perpendicular to the plane of the figure by transmitting the lower quarter wave plate 27. This linearly polarized light is absorbed by the lower polarizing plate 28, so that it does not return outside (toward an observer) and the liquid crystal display performs the dark display.

On the other hand, in performing the display in the transmission mode, the light emitted from the backlight unit 12 enters the liquid crystal cell 11 from outside the lower substrate 13 so as to contribute to the display. In performing the dark display in the transmission mode (right end in FIG. 3), an effect similar to that in the reflection mode is produced from the lower substrate toward the upper substrate. That is, since in FIG. 3, the lower substrate is also provided with the lower polarizing plate 28 and the lower quarter wave plate 27 similarly to the upper substrate, 20% of the circularly polarized light incident in the liquid crystal layer 16 from the lower substrate transmits the transflective layer 18. At this time, if the liquid crystal is in the OFF state, it becomes left circularly polarized light upon reaching the upper substrate so as to be inverted into linearly polarized light having a polarization axis perpendicular to the plane of the figure by transmitting the upper quarter wave plate 35. Since this linearly polarized light is absorbed into the upper polarizing plate 36, it is not emitted outside (toward an observer) and the liquid crystal display performs the dark display.

In performing the bright display in the transmission mode (third from the right in FIG. 3), the light incident from the lower substrate becomes linearly polarized light having a polarization axis parallel to the plane of the figure by transmitting the lower polarizing plate 28, then it becomes right circularly polarized light to be emitted by transmitting the lower quarter wave plate 27. Twenty percent of this emitted light can transmit the transflective layer 18 made of the cholesteric liquid crystal, and it further transmits the dye layer of the color filter layer 30 so as to be emitted as red right circularly polarized light. If the liquid crystal is in the ON state, the 20% right circularly polarized light reaches the upper substrate 14 maintaining the polarized state. Then, the right circularly polarized light is inverted into linearly polarized light having a polarization axis parallel to the plane of the figure by transmitting the upper quarter wave plate 35. Since this linearly polarized light can transmit the upper polarizing plate 36, it returns outside (toward an observer) and the liquid crystal display performs the bright (red) display.

On the other hand, in performing the bright display in the transmission mode, 80% of right circularly polarized light reflects on the transflective layer 18 made of the cholesteric liquid crystal. At this time, as described above, since the cholesteric liquid crystal has a property that it does not change the rotational direction of the reflected circularly polarized light, the reflected light is the right circularly polarized light. Therefore, then by transmitting the lower quarter wave plate 27, the right circularly polarized light becomes linearly polarized light having a polarization axis parallel to the plane of the figure, which can transmit the lower polarizing plate 28 having a transmission axis parallel to the plane of the figure. In such a manner, when the linearly polarized light having the same polarization axis as that the transmission axis of the lower polarizing plate 28 is emitted from the lower substrate, this light is again led toward the liquid crystal cell by reflecting on the reflection plate 40 provided in the backlight unit 12 and reused for the display.

As described above, in the liquid crystal display according to the embodiment, the same display mode can be used in the reflection as well as in the transmission. Focusing especially on the bright display in the transmission mode, part of the light incident from the lower substrate is not absorbed into the upper polarizing plate as is in the conventional transflective liquid crystal display, and the almost entire light transmitted through the transflective layer 18 made of the cholesteric liquid crystal contributes to the display. On the other hand, the light reflected on the transflective layer 18 made of the cholesteric liquid crystal can be reused for the display.

Therefore, by the additive effects that the circularly polarized light transmitted through the transflective layer 18 made of the cholesteric liquid crystal can be utilized utmost and the circularly polarized light reflected on the transflective layer 18 can be reused for the display, the liquid crystal display according to the embodiment can improve the brightness of the transmission display more than it was while maintaining the brightness of the reflection display, so that a transflective-type liquid crystal display excellent in visibility can be achieved.

In the liquid crystal display according to the embodiment, the transflective layer 18 made of the cholesteric liquid crystal layer provided on the lower substrate 13 is formed to the underside of the sealing material 15 for clamping the upper substrate 14 and the lower substrate 13 at a predetermined cell thickness, so that fluctuations in the layer thickness of the cholesteric liquid crystal layer cannot affect the cell thickness of the liquid crystal cell and reduction in display quality by changes in retardation (Δn·d) of the liquid crystal layer due to the fluctuations in the layer thickness of the cholesteric liquid crystal layer can be prevented, enabling yield and product quality to be improved.

In the liquid crystal display according to the embodiment, the color filter layer 30 arranged between the transflective layer 18 made of the cholesteric liquid crystal layer provided on the lower substrate 13 and the first conductive film is formed to the underside of the sealing material 15 for clamping the upper substrate 14 and the lower substrate 13 at a predetermined cell thickness, so that even when the transflective layer 18 made of the cholesteric liquid crystal layer with a thickness of about 5 to 20 μm, for example, and the color filter layer 30 fluctuate in thickness, since fluctuations in the layer thickness of these two layers cannot affect the cell thickness of the liquid crystal cell, reduction in display quality by changes in retardation (Δn·d) of the liquid crystal layer due to the fluctuations in the layer thickness of these two layers can be prevented, enabling yield and product quality to be improved.

In the liquid crystal display according to the embodiment described above, a case has been described, in which the transflective layer 18 comprising a plurality of the cholesteric liquid crystal layers reflects part of white circularly polarized light with the same rotational direction as the spiral winding direction while transmitting the other part; the transflective layer 18 may comprise the cholesteric liquid crystal layer serving as a reflective type color filter, which selectively reflects chromatic light with a different wavelength corresponding to a spiral pitch of a liquid crystal molecule for each predetermined region divided from a display region of the liquid crystal cell 11.

Examples of an electronic instrument having the liquid crystal display according to the embodiment described above will be described.

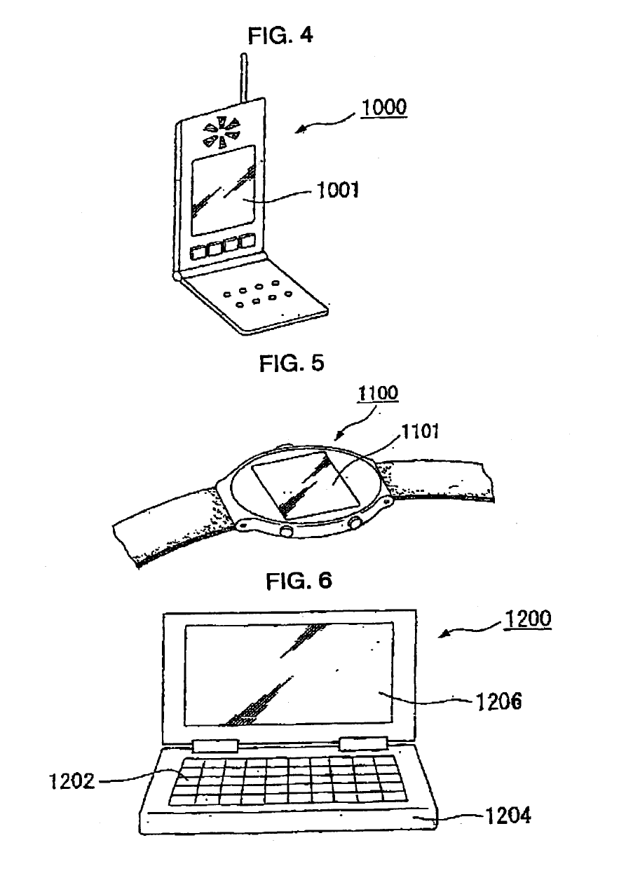

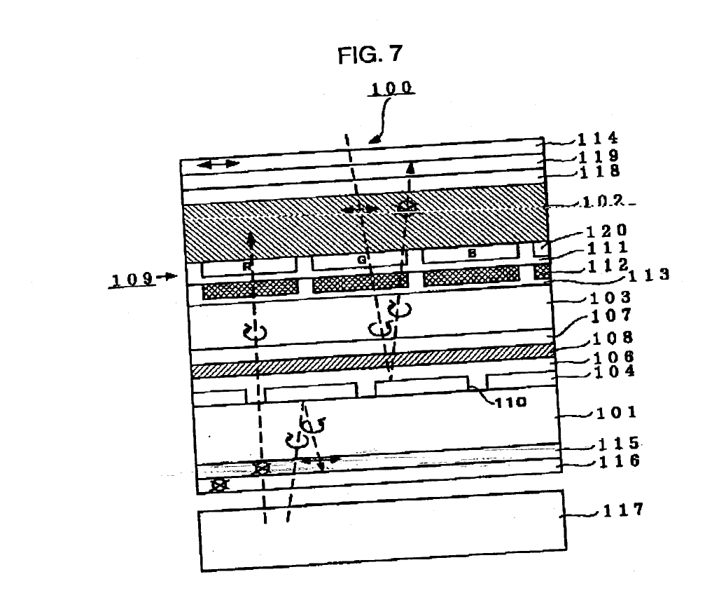

FIG. 4 is a perspective view showing an example of a mobile phone. Referring to FIG. 4, numeral 1000 denotes a mobile phone body and numeral 1001 denotes a liquid crystal display section using the liquid crystal display described above.

FIG. 5 is a perspective view showing an example of a watch type electronic instrument. Referring to FIG. 5, numeral 1100 denotes a watch body and numeral 1101 denotes a liquid crystal display section using the liquid crystal display described above.

FIG. 6 is a perspective view showing an example of a mobile information processing device such as a wordprocessor and personal computer. Referring to FIG. 6, numeral 1200 denotes an information processor; numeral 1202 denotes an input unit such as a key board; numeral 1204 denotes an information processor body; and numeral 1206 denotes a liquid crystal display section using the liquid crystal display described above.

Electronic instruments shown in FIGS. 4 to 6 have a liquid crystal display section using the liquid crystal display described above, so that an electronic instrument having a liquid crystal display section with excellent visibility under various operational circumstances can be achieved, in which bright display can be obtained even in the transmission mode.

The technical scope of the present invention is not limited to the embodiment described above and various modifications can be made within the spirit and scope of the present invention.

The present invention is not limited to the active-matrix type transflective liquid crystal display using the TFD as a switching element as in the embodiment described above; alternatively, a transflective liquid crystal display using a TFT (thin film transistor) as a switching element and a passive-matrix type transflective liquid crystal display may incorporate the present invention. Also, it is not limited to a transflective liquid crystal display and may be applied to a reflective liquid crystal display may be applied; it is not limited to a color liquid crystal display and may be applied a monochrome liquid crystal display may be applied.

In the embodiment described above, as the elliptically-polarized-light projecting means, the polarizing plate and the quarter wave plate are used; alternatively, other optical members may be used as long as they can project elliptically polarized light to the liquid crystal layer.

According to the present invention, it is ideal to project circularly polarized light to the liquid crystal layer for the display; however, it is not necessarily to limit to the precise circularly polarized light and when reduction in utilizing efficiency of light is allowed in some degree, the elliptically polarized light may be used.

[Advantages]

As described above in detail, according to the liquid crystal display of the present invention, the sealing material for clamping the upper substrate and the lower substrate, on which the reflection layer or the transflective layer having the cholesteric liquid crystal layer is provided, at a predetermined cell thickness, is formed on the upper side of the cholesteric liquid crystal layer formed on the lower substrate, so that fluctuations in the layer thickness of the liquid crystal cell due to fluctuations in the layer thickness of the cholesteric liquid crystal layer can be prevented. Also, according to an electronic instrument having such a liquid crystal display, reduction in yield due to fluctuations in the layer thickness of the cholesteric liquid crystal layer is eliminated, and an electronic instrument having a highly reliable liquid crystal display is achieved.

According to the liquid crystal display of the present invention having the transflective layer comprising the cholesteric liquid crystal layer, which reflects part of elliptically polarized light having a predetermined rotational direction while transmitting the other part thereof, a liquid crystal display with excellent visibility is obtained, in which the display brightness in the transmission mode is improved. Also, according to an electronic instrument having such a liquid crystal display, an electronic instrument having the liquid crystal display with excellent visibility, in which the display brightness even in the transmission mode is improved, is achieved.

What is claimed is:

1. A liquid crystal display comprising:
upper and lower substrates, which oppose each other and are bonded to each other with a sealing material;
a liquid crystal layer clamped between the upper and lower substrates;
a liquid crystal cell having a first conductive section disposed to the internal surface of the lower substrate and a second conductive section disposed to the internal surface of the upper substrate;
a reflection layer, which is disposed between the lower substrate and the first conductive section and has a cholesteric liquid crystal layer for reflecting at least part of elliptically polarized light having a predetermined rotational direction;
upper-substrate side elliptically-polarized-light projecting means for projecting elliptically polarized light from the upper substrate toward the liquid crystal layer; and
lower-substrate side elliptically-polarized-light projecting means for projecting elliptically polarized light from the lower substrate toward the liquid crystal layer,
wherein the liquid crystal layer inverts the polarity of incident elliptically polarized light in any one of a selective electric-field impressed state and a nonselective electric-field impressed state while the liquid crystal layer does not invert the polarity in the other state, and
wherein the cholesteric liquid crystal layer is disposed in at least part of the region between the lower substrate and the sealing material disposed to the internal surface of the lower substrate.

2. A display according to claim 1, wherein within the sealing material, a spacer is mixed.

3. A display according to claim 2, wherein the cholesteric liquid crystal layer is provided from the inner edge of the sealing material to a region including at least 50% of the width of the sealing material.

4. A display according to claim 1, wherein the reflection layer is a transflective layer having the cholesteric liquid crystal layer for reflecting part of elliptically polarized light having a predetermined rotational direction and for transmitting the other part thereof, and
wherein the reflection layer is provided with the lower-substrate side elliptically-polarized-light projecting means for projecting elliptically polarized light from the lower substrate.

5. A display according to claim 4, further comprising an illuminating unit for projecting light from the lower substrate toward the liquid crystal cell.

6. A display according to any one of claims 1 to 5, wherein the upper-substrate side elliptically-polarized-light projecting means comprises a polarizing plate for transmitting linearly polarized light in one direction and a retardation plate for inverting the linearly polarized light, which is transmitted through the polarizing plate, into elliptically polarized light.

7. A display according to any one of claims 1 to 6, wherein the lower-substrate side elliptically-polarized-light projecting means comprises a polarizing plate for transmitting linearly polarized light in one direction and a retardation plate for inverting the linearly polarized light, which is transmitted through the polarizing plate, into elliptically polarized light.

8. A display according to any one of claims 1 to 7, wherein the cholesteric liquid crystal layer serves as a reflective color filter, which selectively reflects chromatic light with a different wavelength corresponding to a spiral pitch of a liquid crystal molecule for each predetermined region divided from a display region of the liquid crystal cell.

9. A display according to any one of claims 1 to 8, further comprising a color filter layer having a plurality of dye layers containing different color pigments and arranged between the first conductive section and one of the reflection layer and the transflective layer.

10. A display according to claim 9, wherein at least part of the color filter layer is provided on the underside of the sealing material.

11. A display according to any one of claims 1 to 10, wherein one of the reflection layer and the transflective layer is provided with a plurality of the cholesteric liquid crystal layers having liquid crystal molecules with different spiral pitches.

12. An electronic instrument comprising a liquid crystal display according to any one of claims 1 to 11.
